(19) United States
(12) Patent Application Publication
(10) Pub. No.: US 2026/0368755 A1
(43) Pub. Date: Nov. 19, 2026

(54) TECHNOLOGIES FOR DETERMINISTIC CERTIFICATION INFRASTRUCTURE

(71) Applicant: Theoris Software, Inc., St. Petersburg, FL (US)

(72) Inventor: James J. Cutillo, Alva, FL (US)

(21) Appl. No.: 19/676,386

(22) Filed: May 13, 2026

Related U.S. Application Data
(60) Provisional application No. 63/805,600, filed on May 14, 2025.

(51) Int. Cl. G06Q 30/018

(52) U.S. Cl. CPC G06Q 30/018

(57) ABSTRACT

Technologies for a deterministic certification infrastructure include a control plane device in communication with multiple participant nodes that are each within respective sovereign boundaries. The control plane device defines one or more controls as deterministic assertion units that reference canonical data elements in a reference ontology and binds the controls into a versioned control pack. The control plane deploys the control pack with an associated policy to a participant node. The participant node executes a certification run with the control pack and the policy in a participant sovereign node, retrieves participant data from one or more data sources, normalizes the participant data according to the reference ontology, evaluates controls of the control pack with normalized participant data, and generates a signed certification artifact. The reference ontology may be aligned to a regulated asset domain such as a residential mortgage domain. Other embodiments are described and claimed.

### CROSS-REFERENCE TO RELATED APPLICATION

This application claims the benefit of and priority to U.S. Patent Application No. 63/805,600, entitled “System and Method for Domain Specific Multi-Agent Orchestration and Source-of-truth Resolution and Verification of Mortgage Data to Ensure Loan Salability and Serviceability,” which was filed on May 14, 2025, and which is incorporated herein by reference in its entirety.

### BACKGROUND

Typical regulated financial ecosystems, such as mortgage asset markets, rely on repeated validation of data and documents at each institutional handoff. Existing technical systems for data and document validation include rule engines; workflow engines; governance, risk, and compliance (GRC) platforms; cloud-based compliance services; and robotic process automation (RPA) systems. Such conventional systems still typically require manual re-review of underlying evidence and do not provide immutable, cryptographically secured, deterministic, and automated validation or replayability.

### BRIEF DESCRIPTION OF THE DRAWINGS

The concepts described herein are illustrated by way of example and not by way of limitation in the accompanying figures. For simplicity and clarity of illustration, elements illustrated in the figures are not necessarily drawn to scale. Where considered appropriate, reference labels have been repeated among the figures to indicate corresponding or analogous elements.

FIG. 1 is a simplified block diagram of at least one embodiment of a system for a deterministic certification infrastructure including a control plane device and multiple participant nodes;

FIG. 2 is a simplified block diagram of at least one embodiment of various environments that may be established by the system of FIG. 1;

FIG. 3 is a simplified flow diagram of at least one embodiment of a method for deterministic governance logic management that may be executed by a control plane device of FIG. 1;

FIG. 4 is a schematic diagram of an enterprise data fabric that may be established by the system of FIG. 1;

FIGS. 5 and 6 are a simplified flow diagram of at least one embodiment of a method for deterministic governance control execution that may be executed by a participant node of FIG. 1;

FIG. 7 is a simplified flow diagram of at least one embodiment of a method for control execution that may be executed by a participant node of FIG. 1 in connection with the method of FIGS. 5 and 6;

FIG. 8 is a simplified state transition diagram for a certification artifact that may be used in connection with the methods of FIGS. 5-7;

FIG. 9 is a schematic diagram of a structured control output that may be generated in connection with the methods of FIGS. 5-7;

FIG. 10 is a simplified flow diagram of at least one embodiment of a method for deterministic governance control replay and verification that may be executed by a participant node or other device of FIG. 1;

FIG. 11 is a simplified block diagram of at least one embodiment of another environment that may be established by a device of the system of FIG. 1; and

FIG. 12 is a simplified flow diagram of at least one embodiment of a method for executing domain-specific deterministic task models that may be executed by a control plane device or other device of FIG. 1.

### DETAILED DESCRIPTION OF THE DRAWINGS

While the concepts of the present disclosure are susceptible to various modifications and alternative forms, specific embodiments thereof have been shown by way of example in the drawings and will be described herein in detail. It should be understood, however, that there is no intent to limit the concepts of the present disclosure to the particular forms disclosed, but on the contrary, the intention is to cover all modifications, equivalents, and alternatives consistent with the present disclosure and the appended claims.

References in the specification to “one embodiment,” “an embodiment,” “an illustrative embodiment,” etc., indicate that the embodiment described may include a particular feature, structure, or characteristic, but every embodiment may or may not necessarily include that particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to effect such feature, structure, or characteristic in connection with other embodiments whether or not explicitly described. Additionally, it should be appreciated that items included in a list in the form of “at least one A, B, and C” can mean (A); (B); (C); (A and B); (A and C); (B and C); or (A, B, and C). Similarly, items listed in the form of “at least one of A, B, or C” can mean (A); (B); (C); (A and B); (A and C); (B and C); or (A, B, and C).

The disclosed embodiments may be implemented, in some cases, in hardware, firmware, software, or any combination thereof. The disclosed embodiments may also be implemented as instructions carried by or stored on a transitory or non-transitory machine-readable (e.g., computer-readable) storage medium, which may be read and executed by one or more processors. A machine-readable storage medium may be embodied as any storage device, mechanism, or other physical structure for storing or transmitting information in a form readable by a machine (e.g., a volatile or non-volatile memory, a media disc, or other media device).

In the drawings, some structural or method features may be shown in specific arrangements and/or orderings. However, it should be appreciated that such specific arrangements and/or orderings may not be required. Rather, in some embodiments, such features may be arranged in a different manner and/or order than shown in the illustrative figures. Additionally, the inclusion of a structural or method feature in a particular figure is not meant to imply that such feature is required in all embodiments and, in some embodiments, may not be included or may be combined with other features.

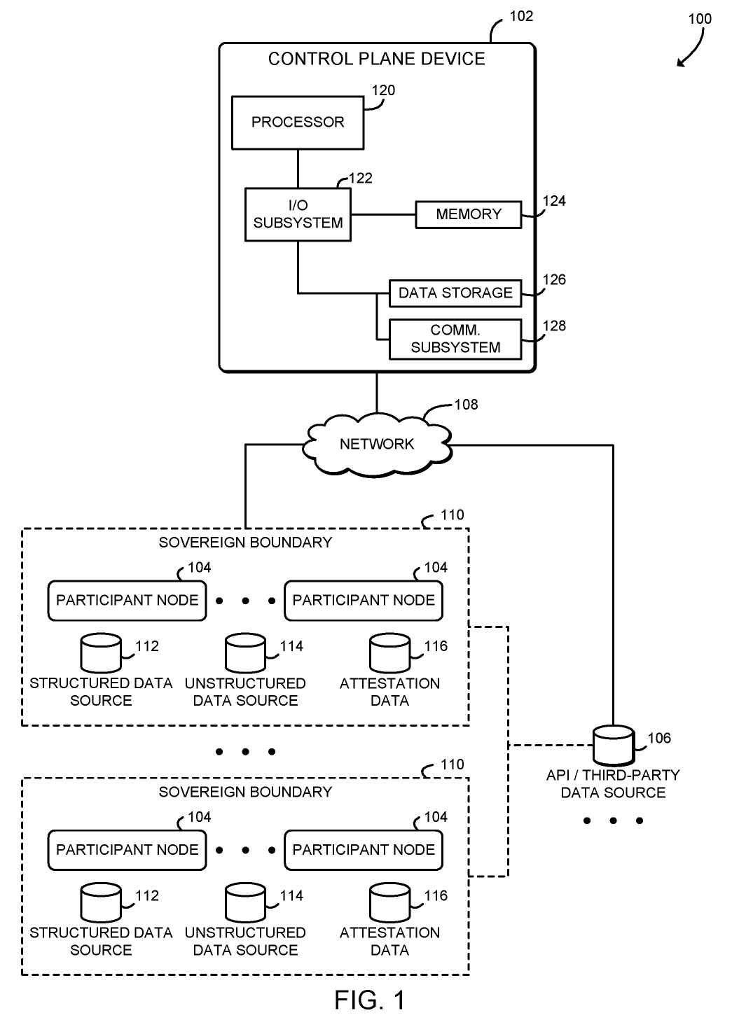

Referring now to FIG. 1, an illustrative system 100 for a deterministic certification infrastructure includes a control plane device 102 which is in communication with one or more participant nodes 104. In use, as described further below, the control plane device 102 generates and packages governance controls into control packs. Each control specifies governance assertions in terms of a reference ontology, which is specific to a domain, such as a residential mortgage domain or other regulated asset domain. Once published, control packs are deployed to sovereign participant nodes 104, which deterministically evaluate the controls against participant data. The participant nodes 104 generate signed certification artifacts based on evaluation of the controls. Those signed certification artifacts can be verified and replayed by other entities of the system 100 without requiring access to participant data. Accordingly, the system 100 provides a computer-implemented system for regulated asset certification, deterministic execution infrastructure, governance-bound control architecture, and cryptographically verifiable, replayable compliance systems deployed within participant-controlled computing environment. Thus, the disclosed system 100 improves over existing systems by providing immutable, cryptographically secured, and deterministic certification that does not have to be re-reviewed or otherwise re-processed at every institutional handoff or other event.

For example, as described further below, the disclosed system 100 prohibits runtime mutation of logic or in-place mutation of certification state, provides immutable version lineage binding, provides deterministic replay under identical version bindings, immutable control pack activation constraints, governance-plane / execution-plane separation, sovereign node execution isolation, state-machine enforced certification transitions, and portable signed certification artifacts verifiable without re-review of underlying evidence. Those features are improvements over existing certification systems such as rule engines, workflow engines, RPA systems, GRC platforms, or cloud-based AI orchestration platforms. As another example, and as described further below, the disclosed system 100 provides cryptographically bound execution contracts, version drift detection preventing execution, immutable supersession state recording, sovereign node isolation of execution authority, replayable certification under artifact hash equality, and cross-run lineage synchronization via a master asset identifier (MAI).

The control plane device 102 may be embodied as any type of device capable of performing the functions described herein. For example, the control plane device 102 may be embodied as, without limitation, a server, a rack-mounted server, a blade server, a workstation, a desktop computer, a laptop computer, a network appliance, a web appliance, a tablet computer, a smartphone, a consumer electronic device, a distributed computing system, a multiprocessor system, and/or any other computing device capable of performing the functions described herein. Additionally, in some embodiments, the control plane device 102 may be embodied as a “virtual server” formed from multiple computing devices distributed across a network and operating in a public or private cloud. Accordingly, although the control plane device 102 is illustrated in FIG. 1 as embodied as a single computing device, it should be appreciated that the control plane device 102 may be embodied as multiple devices cooperating together to facilitate the functionality described below.

As shown in FIG. 1, the illustrative control plane device 102 includes a processor 120, an I/O subsystem 122, memory 124, a data storage device 126, and a communication subsystem 128. Of course, the control plane device 102 may include other or additional components, such as those commonly found in a server computer (e.g., various input/output devices), in other embodiments. Additionally, in some embodiments, one or more of the illustrative components may be incorporated in, or otherwise form a portion of, another component. For example, the memory 124, or portions thereof, may be incorporated in the processor 120 in some embodiments.

The processor 120 may be embodied as any type of processor or compute engine capable of performing the functions described herein. For example, the processor may be embodied as a single or multi-core processor(s), digital signal processor, microcontroller, or other processor or processing/controlling circuit. Similarly, the memory 124 may be embodied as any type of volatile or non-volatile memory or data storage capable of performing the functions described herein. In operation, the memory 124 may store various data and software used during operation of the control plane device 102 such as operating systems, applications, programs, libraries, and drivers. The memory 124 is communicatively coupled to the processor 120 via the I/O subsystem 122, which may be embodied as circuitry and/or components to facilitate input/output operations with the processor 120, the memory 124, and other components of the control plane device 102. For example, the I/O subsystem 122 may be embodied as, or otherwise include, memory controller hubs, input/output control hubs, firmware devices, communication links (i.e., point-to-point links, bus links, wires, cables, light guides, printed circuit board traces, etc.) and/or other components and subsystems to facilitate the input/output operations. In some embodiments, the I/O subsystem 122 may form a portion of a system-on-a-chip (SoC) and be incorporated, along with the processor 120, the memory 124, and other components of the control plane device 102, on a single integrated circuit chip.

The data storage device 126 may be embodied as any type of device or devices configured for short-term or long-term storage of data such as, for example, memory devices and circuits, memory cards, hard disk drives, solid-state drives, or other data storage devices. The communication subsystem 128 of the control plane device 102 may be embodied as any communication circuit, device, or collection thereof, capable of enabling communications between the control plane device 102 and remote devices. The communication subsystem 128 may be configured to use any one or more communication technology (e.g., wireless or wired communications) and associated protocols (e.g., Ethernet, Bluetooth®, Wi-Fi®, WiMAX, etc.) to effect such communication.

Each participant node 104 may be embodied as, without limitation, a server, a rack-mounted server, a blade server, a workstation, a desktop computer, a laptop computer, a network appliance, a web appliance, a tablet computer, a smartphone, a consumer electronic device, a distributed computing system, a multiprocessor system, and/or any other computing device capable of performing the functions described herein. Accordingly, each participant node 104 may include components and devices commonly found in a workstation computer or similar computing device, such as a processor, an I/O subsystem, a memory, a data storage device, a communication subsystem, various I/O devices, and/or other devices. Those individual components of the participant node 104 may be similar to the corresponding components of the control plane device 102, the description of which is applicable to the corresponding components of the participant node 104 and is not repeated herein so as not to obscure the present disclosure.

As shown, the participant nodes 104 and/or the control plane device 102 may communicate with one or more APIs or other third-party data sources 106. Each of those third-party data sources 106 may be embodied as, without limitation, a server device and/or a virtual server similar to the control plane device 102. Accordingly, each third-party data source 106 may include components and devices commonly found in a server or similar computing device, such as a processor, an I/O subsystem, a memory, a data storage device, a communication subsystem, various I/O devices, and/or other devices. Those individual components may be similar to the corresponding components of the control plane device 102, the description of which is not repeated herein so as not to obscure the present disclosure.

As shown in FIG. 1, the control plane device 102, the participant node 104, and other components of the system 100 are configured to transmit and receive data with each other and/or other devices of the system 100 over a network 108. The network 108 may be embodied as any number of various wired and/or wireless networks. For example, the network 108 may be embodied as, or otherwise include, a wired or wireless local area network (LAN), a wired or wireless wide area network (WAN), and/or a publicly-accessible, global network such as the Internet. As such, the network 108 may include any number of additional devices, such as additional computers, routers, and switches, to facilitate communications among the devices of the system 100.

As shown in FIG. 1, each of the illustrative participant nodes 104 is included within a sovereign boundary 110. The sovereign boundary 110 may be embodied as a physical or logical partition for data and systems for a particular participant. The participant may be, for example, a particular enterprise, client, facility, premises, or other entity. The sovereign boundary 110 represents a boundary of security and control, such as a participant VPC or data center. As shown, each sovereign boundary 110 includes participant data, including one or more structured data sources 112 (such as a structured system of record), unstructured data sources 114 (such as document data), and manual attestation data 114. Each sovereign boundary 110 includes its own participant data, and in some embodiments, the participant data may be prevented from exiting the sovereign boundary or otherwise secured. Accordingly, the illustrative participant node 104 may execution without a shared multi-tenant runtime and/or without cross-participant evidence data pooling. Additionally, as shown, each participant node 104 may also access third-party data sources 106 through the sovereign boundary 110.

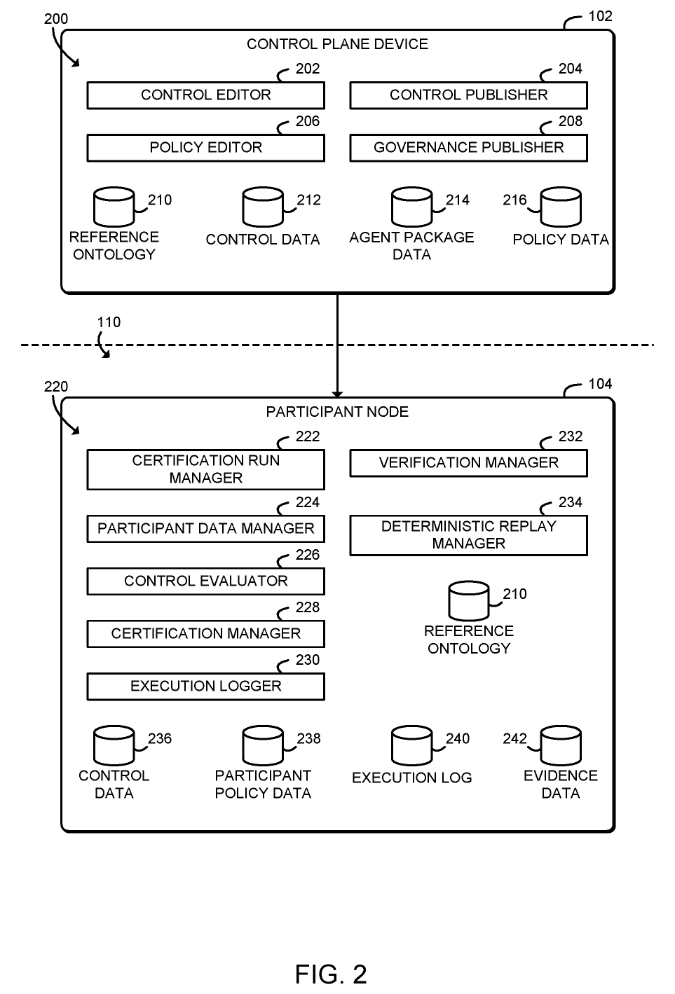

Referring now to FIG. 2, in the illustrative embodiment, the control plane device 102 establishes an environment 200 during operation. The illustrative environment 200 includes a control editor 202, a control publisher 204, a policy editor 206, and a governance publisher 208. The various components of the environment 200 may be embodied as hardware, firmware, software, or a combination thereof. As such, in some embodiments, one or more of the components of the environment 200 may be embodied as circuitry or a collection of electrical devices (e.g., control editor circuitry 202, control publisher circuitry 204, policy editor circuitry 206, and/or governance publisher circuitry 208). It should be appreciated that, in such embodiments, one or more of those components may form a portion of the processor 120, the I/O subsystem 122, and/or other components of the control plane device 102.

The control editor 202 is configured to define one or more controls as deterministic assertion units. Each control references one or more canonical data elements in a reference ontology 210. For example, in the illustrative embodiment, the reference ontology 210 is aligned with a mortgage industry data model. In some embodiments, defining a control further includes defining a certification assertion in terms of the canonical data elements. In some embodiments, defining the certification assertion further includes defining multiple assertion outcome classes illustratively selected from pass, fail, incomplete, and exception. In some embodiments, defining a control further includes defining a source-of-truth for the canonical data elements and/or defining a threshold parameter or a tolerance parameter.

The control publisher 204 is configured to bind one or more controls to a control pack. Each control pack is associated with a control pack version, and may be further associated with a reference ontology version. The control publisher 204 is further configured to publish a control pack with an immutable reference to the associated control pack version. In some embodiments, controls, control packs, and/or associated metadata may be stored in control data 212.

The policy editor 206 is configured to define a policy associated with each control pack for a governance context. In some embodiments, defining a policy comprises includes defining a threshold overlay, defining required controls and optional controls of the associated control pack, and/or defining an outcome classification configuration.

The governance publisher 208 is configured to deploy a published control pack and associated policy to a participant node 104 within a sovereign boundary 110. In some embodiments, the governance publisher 208 is further configured to compose an agent with the published control pack and associated policy. This agent may be deployed to the participant node 104. As described further below, in response to deployment, the participant node 104 may activate a particular control pack version associated with the deployed control pack.

Still referring to FIG. 2, in the illustrative embodiment, a participant node 104 establishes an environment 220 during operation. The illustrative environment 220 includes a certification run manager 222, a participant data manger 224, a control evaluator 226, a certification manager 228, an execution logger 230, a verification manager 232, and a deterministic replay manager 234. The various components of the environment 220 may be embodied as hardware, firmware, software, or a combination thereof. As such, in some embodiments, one or more of the components of the environment 220 may be embodied as circuitry or a collection of electrical devices (e.g., a certification run manager circuitry 222, participant data manger circuitry 224, control evaluator circuitry 226, certification manager circuitry 228, execution logger circuitry 230, verification manager circuitry 232, and/or deterministic replay manager circuitry 234). It should be appreciated that, in such embodiments, one or more of those components may form a portion of the processor, the I/O subsystem, and/or other components of the participant node 104.

The certification run manager 222 is configured to execute a certification run with a control pack and associated policy in a participant sovereign node, such as the participant node 104 within the sovereign boundary 110. The control pack may be deployed from the control plane server 102 as described above, and may be stored in control data 236 of the participant node 104. Each certification run is associated with a corresponding certificate run identifier, and in some embodiments may be further associated with a corresponding mortgage asset identifier (MAI). In some embodiments, the certification run manager 222 is further configured to monitor for a certification run event, and, in response, activate the participant sovereign node. In some embodiments, the certification run event includes mortgage asset creation, a policy change, a control change, or an evidence change. In some embodiments, the certification run in the participant sovereign node is executed within a trusted execution environment. In some embodiments, executing the certification run includes activating external data protections and/or exporting telemetry indicative of a performance metric and a version identifier.

In some embodiments, executing the certification run with the control pack and the associated policy includes verifying that the control pack is activated and not superseded. In some embodiments, executing the certification run with the control pack and the associated policy includes applying a participant policy overlay to the associated policy. The participant policy overlay and/or policy may be stored in participant policy data 238. In some embodiments, executing the certification run with the control pack and the associated policy includes specifying a participant source-of-truth (SOT). In some embodiments, executing the certification run with the control pack and the associated policy includes generating an execution contract bound to the control pack and the associated policy.

The participant data manger 224 is configured to retrieve participant data from one or more data sources. The data sources include data sources within the sovereign boundary 110 associated with the participant sovereign node 104, such as the structured data 112 (e.g., a structured system of record (SOR)), the unstructured data 114 (e.g., a document-derived data source), and/or the attestation data 116 (e.g., manual attestation data). In some embodiments, participant data is retrieved from a third-party data source 106 (e.g., an API or other source) outside the sovereign boundary 110. The participant data manager 224 is further configured to normalize the participant data to a unified internal representation with predetermined semantic definitions in the reference ontology 210. In the illustrative embodiment, the reference ontology is aligned with a mortgage industry data model. In some embodiments, normalizing the participant data to the unified internal representation includes preserving lineage metadata and source classification of the participant data. In some embodiments, normalizing the participant data to the unified internal representation includes extracting, classifying, or structuring evidence from unstructured data of the participant data with a large language model (LLM). In some embodiments, the LLM may be embodied as a micro-LLM that has been fine-tuned or otherwise refined for a particular domain, such as a regulated asset domain, a residential mortgage domain, or other domain. The participant data and/or the unified internal representation of the participant data may be stored in evidence data 242.

The control evaluator 226 is configured to controls of the control pack deterministically using the unified internal representation. Evaluating a control includes determining an assertion outcome. In some embodiments, the assertion outcome includes pass, fail, incomplete, or exception. In some embodiments, evaluating a control of the control pack deterministically using the unified internal representation includes verifying document presence and completeness, resolving document lineage authority and version, retrieving canonical data specified by the control from the unified internal representation, and applying a source-of-truth hierarchy and resolving conflicts.

The certification manager 228 is configured to determine a certification state in response to evaluating the controls of the control pack. In some embodiments, determining the certification state includes aggregating multiple required assertion outcomes for multiple controls of the control pack. In some embodiments, determining the certification state includes evaluating a completeness rule defined by the associate policy. In some embodiments, determining the certification state includes applying exception logic. The certification manager 228 is further configured to generate a signed certification artifact indicative of the determined certification state. The signed certification artifact is bound to the certificate run identifier associated with the certificate run, and is signed with a participant private key, which is private to the participant node 104 and/or private to the sovereign boundary 110. In some embodiments, generating the signed certification artifact includes binding the signed certification artifact to structured output from the controls of the control pack.

The execution logger 230 is configured to append the certificate run identifier to an immutable execution log 240. In some embodiments, appending the certificate run identifier further includes appending a version reference to the immutable execution log 240. In some embodiments, appending the certificate run identifier further includes appending the structured output from the controls of the control pack to the immutable execution log 240.

The verification manager 232 is configured to receive an execution contract and a signed certification artifact. The execution contract is bound to a control pack and an associated policy, and the signed certification artifact is signed by a participant private key and is indicative of one or more assertion outcomes for the control pack. The verification manager 232 is further configured to verify the signed certification artifact. In some embodiments, verifying the signed certification artifact includes validating a signature authenticity of the signed certification artifact and/or validating version reference integrity of the signed certification artifact.

The deterministic replay manager 234 is configured to deterministically reproduce a replayed certification for the execution contract in response to verifying the signed certification artifact. The replayed certification is indicative of a replayed assertion outcome for the control pack. The deterministic replay manager 234 is further configured to compare the signed certification artifact to the replayed certification. Comparing includes comparing an assertion outcome of the signed certification artifact to the replayed assertion outcome. In some embodiments, deterministically reproducing the replayed certification for the execution contract includes confirming a same evidence snapshot, confirming a same control pack version, confirming a same policy version, and confirming a same unified internal representation between the replayed certification and the signed certification artifact.

Additionally or alternatively, it should be understood that in some embodiments, the various devices of the system 100 may establish other environments with a different arrangement and/or combination of components as compared to the environments 200, 220. For example, in an embodiment, the control plane device 102 may also establish a verification manager 232 and a deterministic replay manager 234 to perform deterministic governance control replay and verification. As another example, a participant node 104 may omit the verification manager 232 and a deterministic replay manager 234 to perform deterministic governance control execution without replay and verification. As yet another example, a participant node 104 may establish an environment including only the verification manager 232 and the deterministic replay manager 234, for example to replay and verify certifications performed by other participant nodes 104. Of course, other combinations are possible in other embodiments.

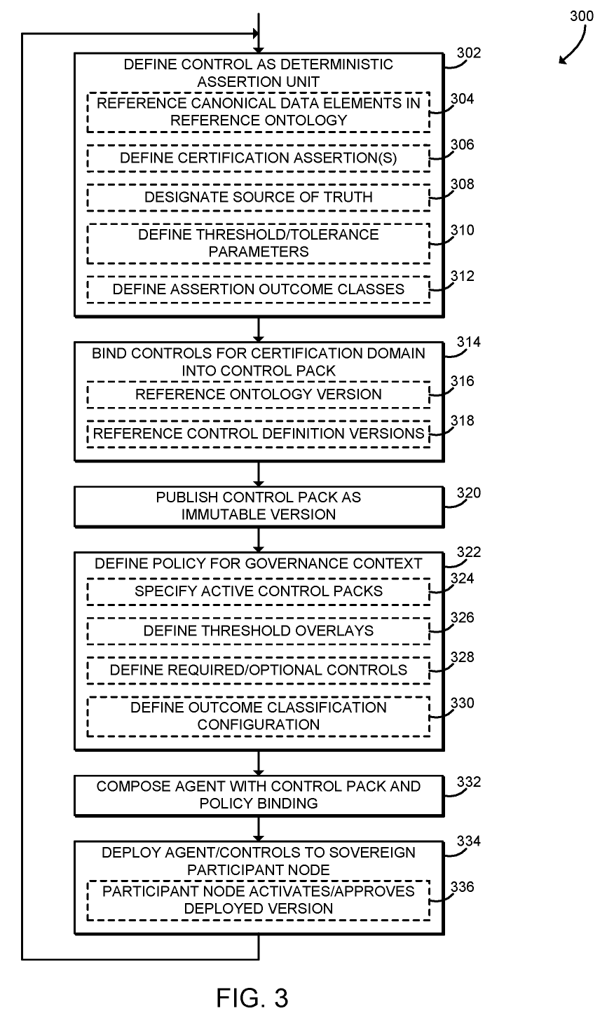

Referring now to FIG. 3, in use, the control plane device 102 may execute a method 300 for deterministic governance logic management. It should be appreciated that, in some embodiments, the operations of the method 300 may be performed by one or more components of the environment 200 of the control plane device 102 as shown in FIG. 2. The method 300 begins with block 302, in which the control plane device 102 defines a control as a deterministic assertion unit. As described further below, controls are embodiment as enforceable execution units that convert policies and normalized data/structural relationships into deterministic certification assertions. Controls are also versioned, with new versions superseding previous versions rather than replacing them. In some embodiments, in block 304 the control plane device 102 references canonical data elements in the reference ontology 210. In some embodiments, in block 306 the control plane device 102 defines one or more certification assertions. The certification assertions may be defined in terms of the canonical data elements and navigates ontology-defined structural relationships between elements. In some embodiments, in block 308 the control plane device 102 designates a source-of-truth (SOT). The SOT may be used, for example, to resolve a final value in the presence of a conflict, and may be specified or adjusted by the participant as described further below. The control plane device 102 thus may embed SOT evaluation capability within control definitions. As described further below, SOT designation authority remains with the participant. In some embodiments, in block 310 the control plane device 102 defines one or more threshold/tolerance parameters for the certification assertions. In some embodiments, in block 312 the control plane device 102 defines assertion outcome classes, such as pass, fail, incomplete, or exception. The assertion outcome classes may represent structured, audit-referenced outcomes.

In block 314, the control plane device 102 binds multiple controls for a certification domain into a control pack. The certification domain may be a regulated asset domain such as, illustratively, a residential mortgage domain. The control pack represents a defined compliance or operational domain and defines required assertions for a certification run. In some embodiments, in block 316 the control plane device 102 references an ontology version for the reference ontology 210 when binding the controls to the control pack. In some embodiments, in block 318 the control plane device 102 references a control definition version. Thus, the control plane device 012 enforces version immutability and prevents retroactive mutation of controls.

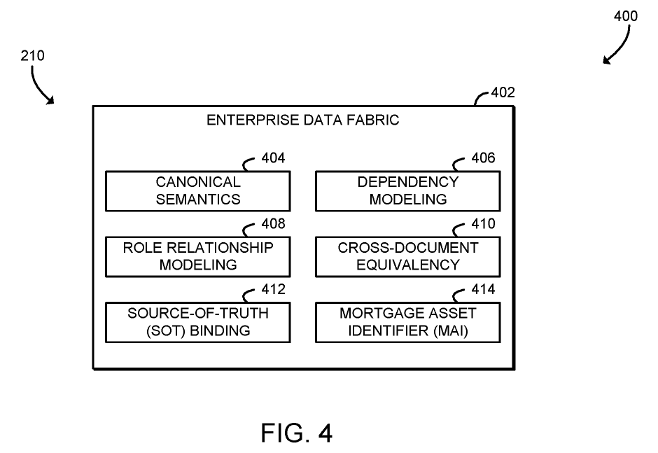

In block 320, the control plane device 102 publishes an immutable version of the control pack. As each control pack version is immutable, subsequent versions of the control pack may supersede the published control pack version with a required version increment, but the published control pack version remains available, for example for deterministic replay and verification of certification artifacts. Thus, published control packs are version-bound artifacts. Additionally or alternatively, in some embodiments, the control plane device 102 may also publish the reference ontology 210, an immutable version of the reference ontology 210, dependency graph metadata, and/or other data related to the reference ontology. In an embodiment, each artifact (e.g., control, control pack, policy, ontology scheme, dependency graph, or other artifact) is cryptographically hashed upon publication, and may be assigned a version identifier and stored in an immutable registry. Post-publication modification of activated artifacts is thus programmatically prevented. In some embodiments, that information may be included in or otherwise published with an enterprise data fabric as illustrated in FIG. 4 and described further below.

In block 322, the control plane device 102 defines a policy for a governance context. In some embodiments, the policy may be defined as a policy template, with parameters (e.g., thresholds, tolerances, SOT sources, etc.) that may be set for a particular participant. Such policy templates provide governance overlays, define thresholds, define activation rules, and define conditional applicability, but do not modify deterministic control logic. Thus, policy binds thresholds, activation context, and outcome classification, but does not alter control evaluation logic. In other words, policy configured execution context, while control defines deterministic logic.

In some embodiments, in block 324 the control plane device 102 specifies one or more active control packs for the governance context in the policy. In some embodiments, in block 326 the control plane device 102 defines threshold overlays for governance context in the policy. In some embodiments, in block 328 the control plane device 102 defines required and/or optional controls for the governance context in the policy. In some embodiments, in block 330 the control plane device 102 defines an outcome classification configuration for the governance context in the policy.

In block 332, the control plane device 102 composes an agent with a published control pack and policy binding. Accordingly, a control pack may be bound a policy version, fore example through a composed agent. The composed agent may be packaged as an agent package such as a containerized agent or other deployable asset. The agent may also be constructed from required evidence classes and an assertion set. The agent is a version execution package. The control/governance plane publishes agent definitions (e.g., agent packages), but execution occurs only in the participant sovereign node.

In block 334, the control plane device 102 deploys the agent and/or associated control pack and policy to one or more participant node(s) 104. The agent (including control pack and policy artifacts) are published in a one-way manner from the control plane device 102 to the participant nodes 104. Accordingly, the control plane device 102 of the system 100 operates as a governance and authoring plane that publishes immutable, versioned control packs and policies. The control plane does not execute certification runs or access participant loan-level evidence or other participant data, and does not train models on participant production evidence. In some embodiments, in block 336 each participant node 104 individually activates and/or otherwise approves a deployed agent version. Thus, activation and execution authority remain with the participant (e.g., the entity associated with a particular sovereign boundary 110). The control plane device 102 cannot unilaterally activate control pack upgrades within a participant sovereign node. In some embodiments, deployment of the agent manages agent lifecycle state. For example, control packs and agents may follow lifecycle states from draft, to validated, to activated, to deprecated, to superseded. Only activated versions are executable. Version supersession does not retroactively alter prior certification outcomes. After deploying the agent, the method 300 loops back to block 302 to continue managing and deploying governance controls.

Referring now to FIG. 4, diagram 400 illustrates an enterprise data fabric 402 which may be established by the control plane device 102. The illustrative canonical enterprise data fabric 402 encodes structured semantic relationships and source-of-truth hierarchy. As shown, the enterprise data fabric 402 may be embodied as or otherwise include the reference ontology 210 as described above. As shown, the illustrative enterprise data fabric 402 includes canonical semantics 404, dependency modeling 406, role relationship modeling 408, cross-document equivalency 410, and source-of-truth (SOT) binding 412. The enterprise data fabric 402 further incorporates a mortgage asset identifier (MAI) 414. The MAI 414 operates as a spine anchoring document lineage and portability. Additionally, each of those elements of the data fabric 402 may be associated with lifecycle contextual metadata. Thus, the enterprise data fabric 402 operates as a canonical enterprise data fabric enabling deterministic SOT application. The data fabric 402 stores structural semantics only and does not pool cross-participant evidence.

In an embodiment, each asset is assigned an MAI 414. The MAI 414 links multiple certification runs, lifecycle events, and version metadata. Accordingly, a lineage graph maintains chronological ordering, detects divergence across lifecycle, and records divergence immutably. The MAI 414 enables cross-run lineage without cross-participant evidence pooling.

In an illustrative embodiment, the enterprise data fabric 402 is a domain-specific data fabric specific to the residential mortgage domain. Of course, in other embodiments, the data fabric 402 may be specific to other domains, such as other regulated asset domains. The illustrative data fabric 402 thus incorporates a canonical structural layer across heterogeneous mortgage systems, a lifecycle-aware contextual data model, a master identity spine (MAI-enabled), a deterministic semantic layer for certification, and a version-governed structural dependency engine. The illustrative data fabric 402 is not a data warehouse, is not a shared cloud, and does not aggregate participant data. Rather, the illustrative data fabric 402 defines structural semantics that enable deterministic certification execution inside sovereign participant environments.

Typical enterprise mortgage environments operate across multiple systems of record, legacy Mortgage Industry Standards Maintenance Organization (MISMO) versions, disparate document formats, multiple vendor APIs, lifecycle silos, and redundant reconciliation processes. Typical enterprise mortgage environments do not provide canonical semantic alignment, rationalized party identity, lifecycle stage contextualization, explicit SOT designation, version-bound reproducibility, deterministic replay capability, or guardrails around AI output. Accordingly, in typical systems, loans are reconstructed at each handoff, data is reinterpreted repeatedly, mandates (e.g., UAD, MCD, etc.) require custom transformation per system, legacy payload formats persist, and AI systems operate without structural constraint.

In contrast, the data fabric 402 provides canonical data semantics 404 and structural dependency modeling 406, which include a unified definitions of mortgage data elements. The data fabric 402 further provides cross-document equivalency 410, for example including cross-document semantic normalization and/or field equivalency modeling. The data fabric 402 further provides explicit SOT designation 412.

Additionally, the enterprise data fabric 402 does not interpret data generically, and instead binds data elements, evidence classes, applicable policy, and control dependency trees to lifecycle stage context. Lifecycle stages include, illustratively, origination, underwriting, closing, post-close, warehouse, secondary market, and servicing. Binding to applicable lifecycle stage context eliminates procedural drift.

The illustrative enterprise data fabric 402 anchors enterprise master data management through the mortgage asset identifier (MAI) 414. The MAI 414 unifies heterogeneous system references, anchors lifecycle state transitions, links certification artifacts, preserves provenance, and binds version lineage. The MAI 414 is not a pooled identifier across participants. The MAI 414 operates within sovereign environments. Accordingly, this creates enterprise mortgage activity master data management without operating as a shared cloud warehouse.

As shown, the illustrative enterprise data fabric 402 includes role relationship modeling 408. Across many existing systems (and associated documents and data stores), identical entities are labeled inconsistently. For example, the same party may be labeled as Borrower, Mortgagor, Applicant, Debtor, or Customer. As another example, the same party may be labeled as Investor, Purchaser, or Assignee. As yet another example, the same party may be labeled as Seller, Correspondent, Counterparty. Of course, other examples are possible in other embodiments. Accordingly, the role relationship modeling 408 of the illustrative enterprise data fabric 402 canonically defines party types, models role relationships, aligns cross-system identifiers, prevents identity duplication, and preserves provenance. This establishes structural order across discordant or otherwise heterogeneous data sources.

In some embodiments, the enterprise data fabric 402, including the canonical semantics 404, may be aligned to one or more industry standard interchange models or other standards. For example, in the illustrative embodiment, the enterprise data fabric 402 is aligned to version 3.6 of the Mortgage Industry Standards Maintenance Organization (MISMO) Reference Model. This alignment enables, for example, upgrade of legacy MISMO versions, UAD mapping support, payload transformation standardization, modern submission generation (e.g., MCD), and/or a retirement path for legacy data structures. Accordingly, using the enterprise data fabric 402, older data sources can be normalized and emitted in modern formats without replacing underlying systems.

The illustrative enterprise data fabric 402 provides deterministic certification semantics. As described above, the enterprise data fabric 402 does not execute or otherwise evaluate controls. The enterprise data fabric 402 defines structural semantics that enable deterministic execution. Accordingly, a knowledge graph enabled by the enterprise data fabric 402 models control-to-assertion dependencies, assertion-to-data dependencies, cross-document equivalency, policy-to-control bindings, SOT binding relationships, and lifecycle stage binding. This produces explicit dependency trees, ordered evaluation paths, version-bound reproducibility, and deterministic replay capability.

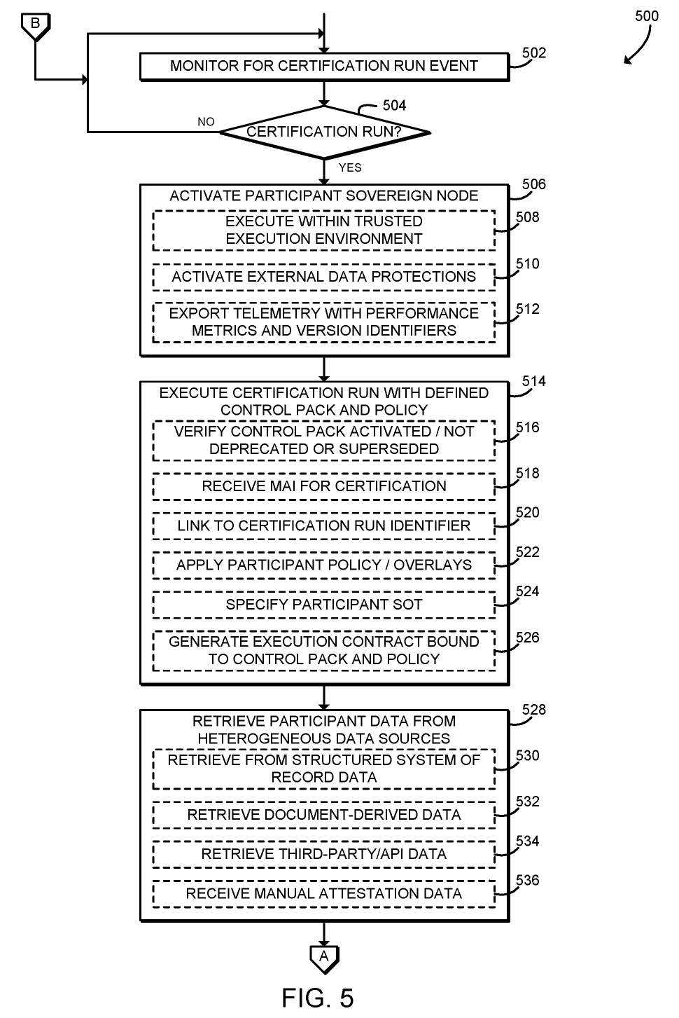

Referring now to FIGS. 5 and 6, in use, a participant node 104 may execute a method 500 for deterministic governance control execution. It should be appreciated that, in some embodiments, the operations of the method 500 may be performed by one or more components of the environment 220 of the participant node 104 as shown in FIG. 2. The method 500 begins with block 502, in which the participant node 104 monitors for a certification run event. Certification run events include, for example, mortgage asset creation, policy changes, control changes, evidence changes, exception resolution, and/or other events. In block 504 the participant node 104 checks whether a certification run should be started. If not, the method 500 loops back to block 502 to continue monitoring for certification run events. If a certification run event occurs, the method 500 advances to block 506.

In block 506, the participant node 104 activates a participant sovereign node. That is, the participant node 104 activates execution with the sovereign boundary 110 or otherwise starts sovereign control execution. Thus, the participant node 104 operates as a participant sovereign execution node that executes deterministic certification logic locally, against participant-local evidence, under participant-bound policy versions, without cross-node runtime coupling, and without runtime involvement of the control plane device 102 or other governance plane components. Thus, execution authority resides exclusively within the participant environment. Further, the availability posture of is governed by the participant’s infrastructure standards. Control execution operates within participant-approved compute environments, supports horizontal scaling of deterministic execution engines, does not require shared multi-tenant infrastructure or shared evidence memory across participants, and does not introduce cross-node runtime coupling. Further, failure of a particular execution instance does not corrupt or mutate prior certification artifacts. Multi-tenant segmentation, where applicable within participant environments, is governed by participant infrastructure policies.

In some embodiments, in block 508 the participant node 104 executes within a trusted execution environment. The trusted execution environment may be an isolated execution container such as a secure enclave or other environment that is secured from multi-tenant access. In some embodiments, certification runs within the same participant sovereign boundary 110 are logically isolated. In such embodiments, execution contexts are independent per certification transaction, and no cross-run memory persistence is required for deterministic execution. In some embodiments, in block 510 the participant node 104 activates external data protections. For example, in an embodiment, when external data protections are activated, no participant evidence, document content, certification data, and/or other participant data may be transmitted outside the sovereign boundary 110. In some embodiments, in block 512 the participant node 104 exports telemetry with performance metrics and version identifiers. Optional telemetry may include, for example, version usage metrics, health signals, non-loan metadata, and control performance indicators. No evidence content is transmitted with the telemetry. Further, telemetry does not include certification data, does not export participant document content, and is configurable and may be disabled by the participant. In some embodiments, no Certification artifacts are transmitted outside the participant sovereign node.

In block 514, the participant node 104 executes certification run with a defined control pack and policy. Executing a certification run cryptographically binds control pack version, policy version, ontology version, assertion set, evidence class scope, and threshold parameters. This binding defines evaluation scope, prevents mutation, enables deterministic replay, and ensures traceable lineage. In some embodiments, in block 516, the participant node 104 verifies that the control pack is activated and not deprecated and/or superseded. In some embodiments, in block 518 the participant node 104 receives a mortgage asset identifier (MAI) for certification. In some embodiments, in block 520 the participant node 104 sinks to an associated certification run identifier. In some embodiments, in block 522 the participant node 104 applies one or more participant policies or other overlays. For example, the participant node 104 may modify one or more policy thresholds based on a participant policy overlay. In some embodiments, in block 524 the participant node 104 specifies participant source-of-truth (SOT). In some embodiments, in block 526, the participant node 104 generates an execution contract bound to the control pack and the policy. Accordingly, the execution contract binds versioned artifacts (e.g., versioned control packs and/or policies) to each certification run. Thus, each control is bound to a particular control pack version and a particular policy version. The certification run may be further bound to one or more identifiers, such as the certification run identifier and/or the MAI.

In an embodiment, the execution contract includes a control pack artifact hash, a policy artifact hash, an ontology artifact hash, an evidence snapshot identifier, an execution environment identifier, and a certification run identifier. This execution contract defines a closed execution scope, prevents artifact substitution, and may be stored in an append-only ledger such as the execution log 240.

Thus, each certification run is executed as a deterministic, version-bound transaction. Certification execution does not require shared memory across runs. Certification runs are isolated and independently reproducible. Execution engines are horizontally scalable within the participant environment. No cross-participant execution dependency exists. No centralized runtime dependency is required for certification completion.

In block 528, the participant node 104 retrieves participant data from heterogeneous data sources. In some embodiments, in block 530 the participant node 104 retrieves data from a structured system-of-record (SOR) data source 112 within the sovereign boundary 110. In some embodiments, in block 530 the participant node 104 retrieves document-derived data, for example from an unstructured data source 114 within the sovereign boundary 110. In some embodiments, in block 534 the participant node 104 retrieves third-party/API data from a third party data source 106, which may be located outside the sovereign boundary 110. In some embodiments, in block 536 the participant node 104 receives manual attestation data 116. The attestation data 116 may be provided by an operator or other user of a node within the sovereign boundary 110.

In block 538, shown in FIG. 6, the participant node 104 normalizes the participant data to a unified internal representation using predetermined semantic definitions. The participant node 104 may, for example, use the enterprise data fabric 402 or other data fabric for normalizing the participant data. In some embodiments, in block 540 the participant node 104 references a predetermined ontology, such as the reference ontology 210. In some embodiments, in block 542 the participant node 104 preserves lineage metadata and source classification of the participant data. In some embodiments, in block 544 the participant node 104 extracts, classifies, and/or structures evidence data with an artificial intelligence model, such as a large language model (LLM), a domain-specific LLM, or other model. Accordingly, model outputs from the LLM may be advisory only, with no freeform decision-making capability afforded to the LLM. In other words, in the system 100, model-assisted components may extract, classify, structure, and/or suggest, but they do not modify ontology structure, alter control dependencies, override SOT designation, or write certification outcomes. Thus, all control definitions remain deterministic and version-bound, which eliminates hallucination risk at the certification layer.

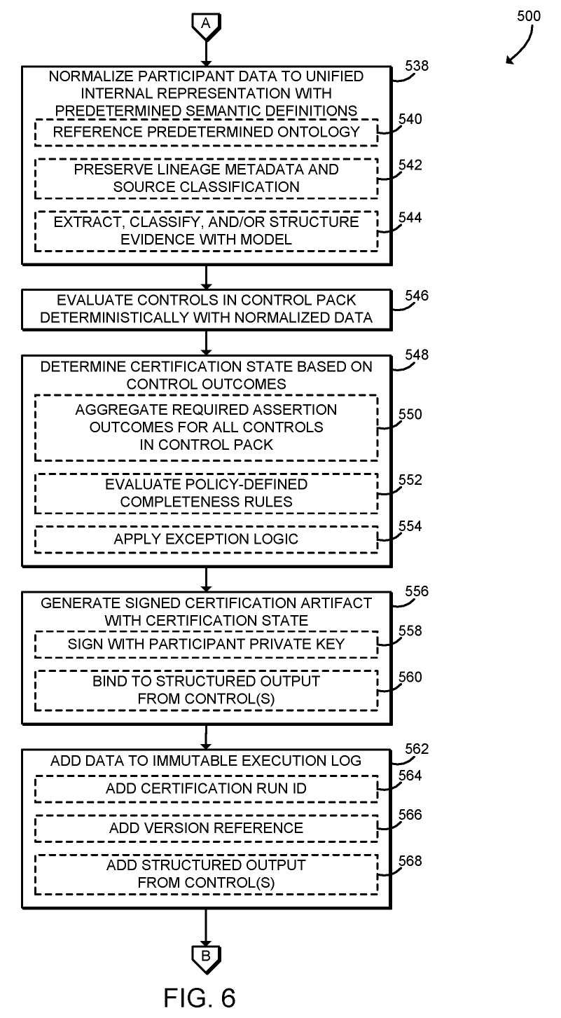

In block 546, the participant node 104 evaluate one or more control(s) in the control pack deterministically with the normalized data. Evaluation of a control includes retrieval of normalized data by canonical data element, reconciliation of source-of-truth (SOT), and evaluation of control assertions. One potential embodiment of a method for evaluating a control is shown in FIG. 7 and described below.

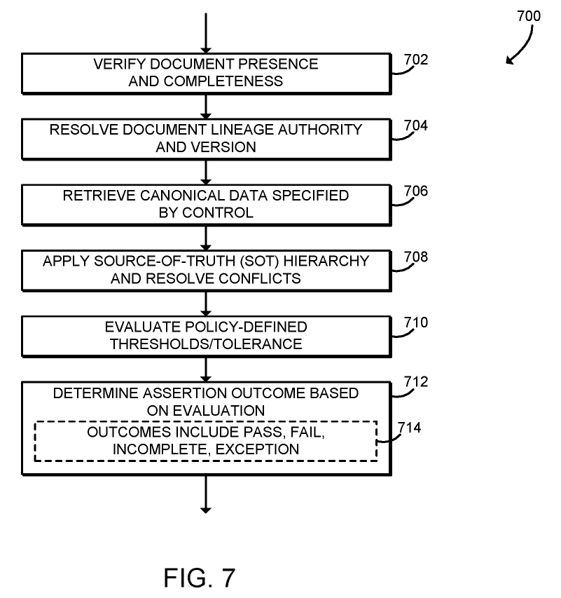

In block 548, the participant node 104 determines a certification state for the control pack based on assertion outcomes for the controls of the control pack. The certification state may transition between certification states based on the assertion outcomes. Accordingly, certification outcomes are produced exclusively through deterministic control evaluation, and are not generated by stochastic model inference or other non-deterministic processes. One potential embodiment of certification state transitions is shown in the diagram of FIG. 8 and described further below. In some embodiments, in block 550 the participant node 104 aggregates required assertion outcomes for all controls in control pack. In some embodiments, in block 552 the participant node 104 evaluates policy-defined completeness rules. In some embodiments, in block 554 the participant node 104 applies exception logic.

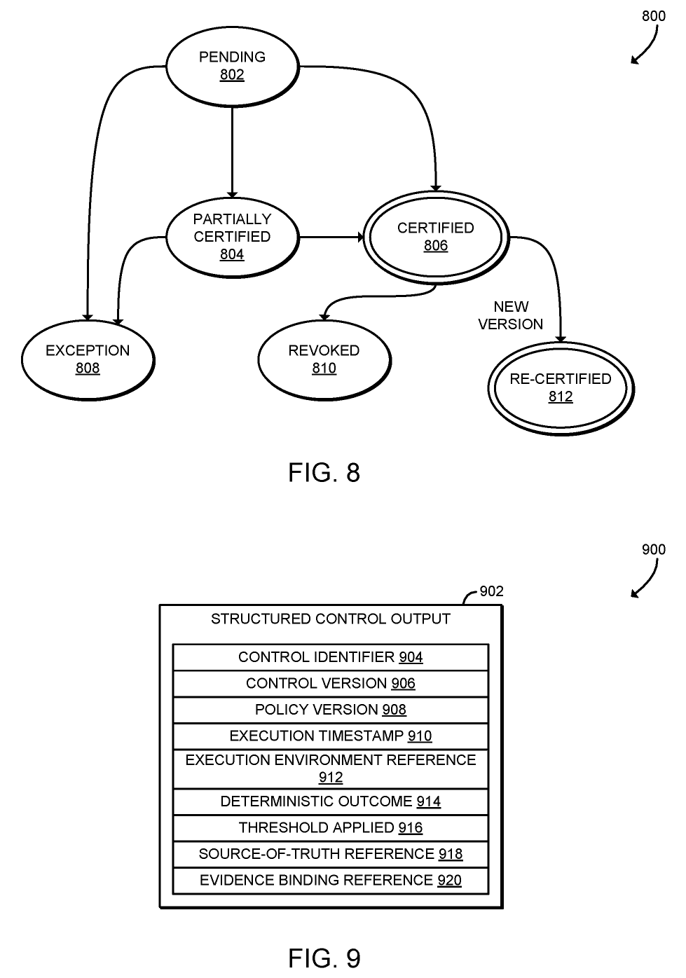

In block 556 the participant node 104 generates a signed certification artifact with the certification state. The signing is performed locally within the sovereign boundary 110, and the signed certification artifact is portable across institutions. For example, in some embodiments, a signed certification artifact may be replayed or otherwise verified by another participant node 104 or other device outside of its generating sovereign boundary 110. In an illustrative embodiment, the signed certification artifact includes an MAI, a certification state, a control pack version, a policy version, an execution environment ID, a timestamp, and a cryptographic signature. Such an artifact is verifiable by an authorized counterparty, does not expose underlying evidence, and does not require re-execution. In some embodiments, in block 558 the participant node 104 signs the certification artifact with a participant private key. The participant private key may be private (e.g., securely stored or otherwise secured) to the participant node 104 and/or to the sovereign boundary 110. For example, in an embodiment, cryptographic key material is generated within participant-controlled infrastructure (e.g., within the sovereign boundary 110). The key material is stored and rotated under participant-defined key management policies, and is not retained or controlled by the control plane device 102 or otherwise retained outside the participant environment. Accordingly, the control plane device 102 (and/or other devices) does not posses authority to independently generate, alter, or invalidate certification artifacts outside of participant-controlled execution environments (e.g., outside of the sovereign boundary 110). Such certification artifacts are environment-bound, version-referenced, and verifiable within a participant authority domain. In some embodiments, in block 560 the participant node 104 binds the certification artifact to structured output from the controls of the control pack. One potential embodiment of structured output generated by the controls is shown in FIG. 9 and described further below.

In block 562, the participant node 104 adds data to the immutable execution log 240. For example, the execution log 240 may be an append-only ledger or other append-only data structure that is cryptographically bound to a certification run, a policy version, a control pack version, and an evidence snapshot. Accordingly, audit records (such as entries in the immutable execution log 240) are append-only, are cryptographically bound to the certification run, reference control pack and policy versions, and preserve execution lineage without retroactive mutation. Historical certification records cannot be altered, and supersession produces new certification artifacts with independent lineage. Audit storage and retention policies are governed by participant infrastructure standards. In some embodiments, in block 564 the participant node 104 adds a certification run ID to the execution log 240. In some embodiments, the participant node 104 adds a version reference to the execution log 240, such as a control pack version, policy version, one or more control version, ontology version, and/or other version references. In some embodiments, in block 568 the participant node 104 adds structured output from the control(s) to the execution log 240. In some embodiments, the participant node 104 may add a reference or other immutable designation of the structured output. After adding the data to the immutable execution log 240, the method 500 loops back to block 502, shown in FIG. 5, to continue monitoring for certification run events.

Referring now to FIG. 7, in use, a participant node 104 may execute a method 700 for control execution. The method 700 may be executed in connection with block 546 of the method 500, as shown in FIG. 6. It should be appreciated that, in some embodiments, the operations of the method 700 may be performed by one or more components of the environment 220 of the participant node 104 as shown in FIG. 2. The method 700 begins with block 702, in which the participant node 104 verifies document presence and completeness. The control, for example, verifies that required document classes exist and confirms that required artifacts are complete.

In block 704, the participant node 104 resolves document lineage authority and version. The control may, for example, resolve document lineage, select and authoritative instance, and apply a precedence hierarchy. Accordingly, execution of a control deterministically resolves required documents.

In block 706, the participant node 104 retrieves canonical data specified by the control. The participant node 104 may, for example, retrieve normalized data elements by canonical identifier. The control may, for example, locate required canonical data elements, extract normalized values, and validate structural integrity. Thus, the control executes against canonical identifiers, and does not dynamically infer schema. Accordingly, the control operates with full awareness of canonical schema identifiers and ontology-defined entity relationships as described above in connection with the enterprise data fabric 402.

In block 708, the participant node 104 deterministically applies a source-of-truth (SOT) hierarchy and resolves conflicts. The participant node 104 may reconcile normalized data with a participant SOT, for example using participant-designated SOT policy bindings and structural hierarchy encoded within an enterprise data fabric. The participant node 104 may, for example, determine a controlling value to resolve cross-document conflicts. Accordingly, the control operates with full awareness of document classification structures, document lineage and authority resolution, and source-of-truth (SOT) hierarchy as described above in connection with the enterprise data fabric 402.

In block 710, the participant node 104 evaluates policy-defined thresholds and/or tolerances. In some embodiments, the thresholds may be defined by policy associated with the control pack. Accordingly, by linking thresholds to versioned policies, runtime threshold modification is prevented. Thus, the control evaluates policy thresholds against authoritative values. Policy modifications may be authorized by participant governance. Such policy modifications bind thresholds, activation context, and outcome classification, but do not alter deterministic control logic.

In block 712, the participant node 104 determines an assertion outcome based on an evaluation. The assertion outcome is based on the assertions included in the published and version-pinned control. Thus, dynamic rule injection is prohibited. Each operation in evaluation of the control is deterministic, version-bound, and replayable. In some embodiments, in block 714 the outcomes include pass, fail, exception, and incomplete. The participant node 104 may generate structured output indicative of the assertion outcome as described further below. After determining the assertion outcome, the method 700 is complete. As described above in connection with the method 500 of FIGS. 5-6, the assertion outcomes from control evaluation may be used to determine a certification state, and the signed certification artifact may be bound to structured output from evaluation of the controls. The method 700 may be executed again, for example, to perform further evaluation of controls.

Referring now to FIG. 8, state transition diagram 800 illustrates one potential embodiment of certification state machine that may be associated with a certification artifact. In an illustrative embodiment, the certification state starts in a pending state 802, which may be an initial state. Depending on the resolution of assertions, the certification state may transition from the pending state 802 to a partially certified state 804, a certified state 806, or an exception state 808. Similarly, the partially certified state 804 may transition to the certified state 806 or the exception state 808. The certified state 806 represents the terminal, fully certified state. Once in the certified state 806, the certification state may transition to a revoked state 810 or a re-certified state 812. The re-certified state 812 may include a new version of the certification asset, rather than mutating or otherwise replacing the original certified state 806. Each state of the state machine may be determined exclusively by deterministic control aggregation, and is immutable once recorded. For example, each state transition may be recorded in an append-only ledger, and prior records cannot be modified. Thus, the certification state machine illustrated in FIG. 8 may enforce immutable state transitions for certification state.

Referring now to FIG. 9, schematic diagram 900 shows at least one illustrative embodiment of structured control output 902 that may be generated during evaluation of a control. The structured control output 902 may include data, references, version information, version lineage references, snapshots, and/or other data indicative of control definitions (e.g., control pack and policy, including SOT designation), the execution environment of the control, the participant data, evidence history, and/or other evidence data assessed with the control, and/or other parameters related to evaluation of the control. The structured output 902 may be cryptographically signed or otherwise bound to a certification run, an execution contract, or otherwise deterministically verifiable. In the illustrative embodiment, the structured control output 902 includes a control identifier 904, a control version 906, a policy version 908, an execution timestamp 910, an execution environment reference 912 (e.g., to the sovereign boundary 110, to a trusted execution environment, and/or to another execution environment), a deterministic assertion outcome 914 (e.g., pass, fail, exception, and/or incomplete), one or more thresholds applied 916, an SOT reference 918, and an evidence binding reference 920 (e.g., evidence snapshot, normalization context reference, or other evidence binding). Such outputs from execution of a control are structured, immutable once recorded, linked to a particular certification run, included in an audit log, and referenced in a certification artifact. Of course, the structured output 902 may include different types and/or a different arrangement of data in other embodiments.

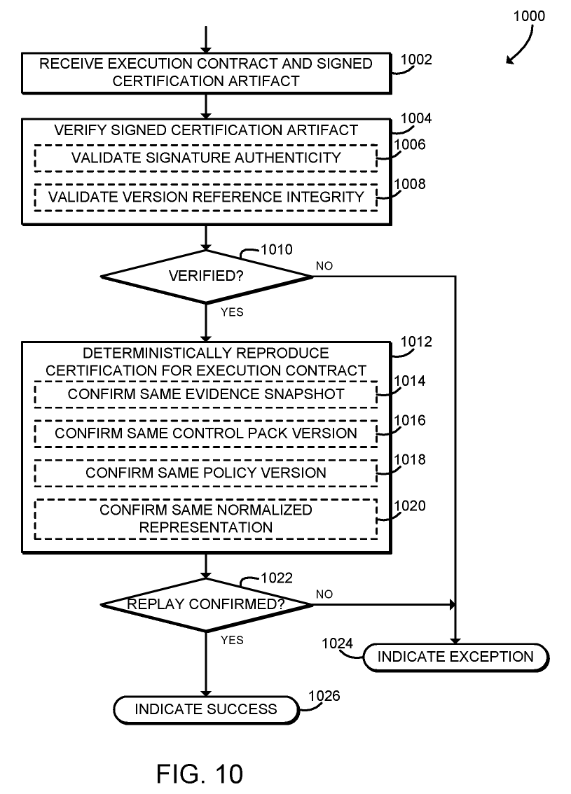

Referring now to FIG. 10, in use, a participant node 104 may execute a method 1000 for deterministic governance control replay and verification. It should be appreciated that, in some embodiments, the operations of the method 1000 may be performed by one or more components of the environment 220 of the participant node 104 as shown in FIG. 2. The method 1000 begins with block 1002, in which the participant node 104 receives an execution contract and a signed certification artifact for replay. Deterministic replay may be supported under the original version bindings for audit and regulatory review, as illustrative examples. As described above, because controls are governance-versioned, policy-bound, fabric-aware, and environment-bound, any certification run can be replayed using an identical control pack version, an identical policy version, and identical evidence inputs. Replay in those circumstances produces identical results. Replay does not require algorithm modification or external dependency reconstruction. Accordingly, in the illustrative embodiment, replay may require versioned control definitions (including an SOT designation), versioned policy, evidence snapshot, and an immutable event log. As described further below, this guarantees deterministic reproducibility.

In block 1004, the participant node 104 verifies the signed certification artifact. In some embodiments, in block 1006 the participant node 104 validates signature authenticity. In some embodiments, in block 1008 the participant node 104 validates version reference integrity. For example, the participant node 104 may employ a version registry, which maintains artifact version identifiers and hashes, prevents modification of activated artifacts, and detects version drift. In block 1010, the participant node 104 checks whether the signed certification artifact was verified. If not, the method 1000 branches to block 1024, in which the participant node 104 indicates an exception. In response to the exception, the participant node 104 may transition a certification state to a revoked state or an exception state as described above or otherwise halt execution. Accordingly, if artifact versions differ from the execution contract bindings, execution is invalidated, replay is denied, and the divergence may be recorded immutably. Referring again to block 1010, if the signed certification artifact was verified, the method 1000 advances to block 1012.

In block 1012, the participant node 104 deterministically reproduces a certification for the received execution contract. Deterministic replay re-executes identical deterministic logic, and thus should produce identical output with no stochastic variability. In the illustrative embodiment, dynamic replay does not require dynamic reconstruction of evidence data or other data. For example, as described above, if classification or normalization engines are used upstream, they normalize evidence into the enterprise mortgage data fabric 402, and they do not determine certification state and do not override deterministic control execution. Accordingly, only deterministic controls determine certification outcomes. This separation ensures structural integrity, compliance defensibility, and elimination of probabilistic drift. In some embodiments, in block 1014 the participant node 104 confirms that the same evidence snapshot is being used for deterministic replay. In some embodiments, in block 1016 the participant node 104 confirms that the same control pack version is being used for deterministic replay. In some embodiments, in block 1018 the participant node 104 confirms that the same policy version is being used for deterministic replay. In some embodiments, in block 1020 the participant node 104 confirms that the same normalized representation of participant data is being used. Accordingly, replay requires identical structure of data.

In block 1022, the participant node 104 checks whether deterministic replay has been successfully confirmed. For example, the participant node 104 may determine whether one or more assertion outcomes from the deterministic replay match the assertion outcomes bound to the signed certification artifact, for example requiring hash equality. That is, identical inputs under identical artifact hashes will produce identical outputs. If the deterministic replay is not successfully confirmed, the method 1000 branches to block 1024, in which the participant node 104 indicates an exception, as described above. If the deterministic replay is successfully confirmed, the method 1000 advances to block 1026, in which the participant node 104 indicates success. This indication of success may represent regulator-defensible reproducibility, ensuring counterparty trust and immutable certification traceability. Accordingly, the associated certification state may remain in the certified state or the re-certified state, as described above. After performing deterministic replay and indicating success or an exception, the method 1000 is completed. The method 1000 may be executed again for further deterministic replay of governance control evaluations.

In an embodiment, the recovery posture of the system 100 is based on deterministic replay and version-bound execution lineage. As described above, each certification run is cryptographically bound to a control pack version, a policy version, an evidence snapshot, and an execution record. Certification history is immutable. Thus, recovery does not rely on reconstructing dynamic execution state. Recovery Time Objective (RTO) and Recovery Point Objective (RPO) targets are governed by participant infrastructure policy. The system does not pool participant evidence outside the sovereign node (e.g., outside of a sovereign boundary 110), does not require cross-participant data restoration, supports deterministic replay under original version bindings, and preserves historical certification lineage under version supersession. As described above, supersession results in new certification runs. Prior outcomes remain unchanged.

Accordingly, as described above, within the participant sovereign node (e.g., a participant node 104 within the sovereign boundary 110) the participant retains authority over SOT designation, policy binding, threshold configuration, agent activation/deprecation, certification execution, replay authorization, audit access control, and artifact distribution. All execution is deterministic and environment-bound. Further, model-assisted services are advisory only and have no outcome authority.

Thus, the disclosed system 100 operates as a managed certification infrastructure utility. The system 100 provides authoring and governance capabilities through the control plane (e.g., the control plane device 102); deterministic execution within sovereign participant nodes 104; version-bound, replayable certification artifacts; strict separation between authoring and execution authority; and no shared data pooling or cross-participant evidence access. As describe above, the governance and authoring plane defines logic, and the participant execution plane performs certification. Thus, trust is bound to version, environment, and evidence, and not to centralized authority.

The disclosed system 100 further provides an enterprise mortgage data fabric with deterministic certification semantics. As described above, the disclosed system 100 provides canonical semantic alignment, lifecycle-aware contextualization, MAI-based master identity spine, MISMO modernization, party rationalization, deterministic dependency modeling, version-bound reproducibility, and replayable certification. Thus, the disclosed system 100 transforms fragmented mortgage ecosystems into certification infrastructure.

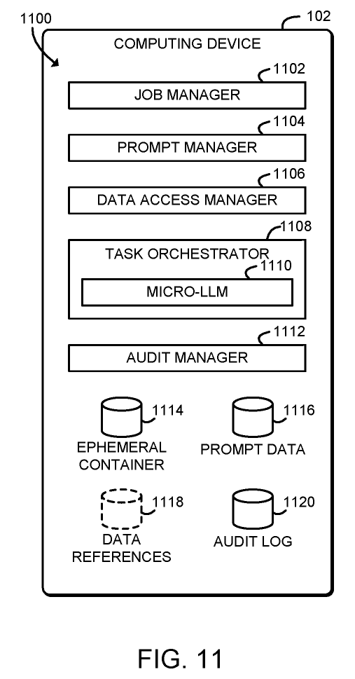

Referring now to FIG. 11, in another illustrative embodiment, a computing device such as the control plane device 102 establishes an environment 1100 during operation. The illustrative environment 1100 includes a job manager 1102, a prompt manager 1104, a data access manager 1106, a task orchestrator 1108, and an audit manager 1112. The various components of the environment 1100 may be embodied as hardware, firmware, software, or a combination thereof. As such, in some embodiments, one or more of the components of the environment 1100 may be embodied as circuitry or a collection of electrical devices (e.g., job manager circuitry 1102, prompt manager circuitry 1104, data access manager circuitry 1106, task orchestrator circuitry 1108, and/or audit manager circuitry 1112). It should be appreciated that, in such embodiments, one or more of those components may form a portion of the processor 120, the I/O subsystem 122, and/or other components of the control plane device 102. Additionally or alternatively, in some embodiments, the components of the environment 1100 may be established by a different device, such as a participant node 104 or other similar computing device.

The job manager 1102 is configured to monitor for job execution events and create a container with an ephemeral execution environment in response to monitoring for the job execution event. The job manager 1102 is further configured to destroy the container in response to the execution of a task, as described further below. The ephemeral execution environment may be stored as an ephemeral container 1114 and instantiated when activated.

The prompt manager 1104 is configured to dynamically generate, with the ephemeral execution environment, a domain-specific prompt for an agent. In some embodiments, the domain-specific prompt is specific to a regulated asset domain, such as a residential mortgage domain. In some embodiments, dynamically generating the domain-specific prompt includes embedding regulatory logic, validation criteria, and reconciliation rules in the domain-specific prompt. The domain-specific prompt may be stored in prompt data 1116.

The data access manager 1106 is configured to securely access, with the ephemeral execution environment, participant data by reference to create a retrieval context. The participant data is accessed via data references 1118. Accordingly, in some embodiments the participant data is not stored permanently by the computing device 102 or otherwise stored within the environment 1100.

The task orchestrator 1108 is configured to execute, with the ephemeral execution environment, a task with a micro-large language model (micro-LLM) 1110 using the domain-specific prompt and the retrieval context. The micro-LLM 1110 is embodied as a fine-tuned, domain-specific language model. In some embodiments, similar to the prompt described above, the domain-specific language model is specific to a regulated asset domain, such as residential mortgage domain. In some embodiments, executing the task includes validating multiple data fields of the participant data. In some embodiments, executing the task includes reconciling a source-of-truth (SOT) for the participant data. In some embodiments, executing the task includes to evaluating regulatory logic.

The audit manager 1112 is configured to emit, with the ephemeral execution environment, an audit log entry in response to execution of the task. The audit log entry may be stored in an immutable audit log 1120.

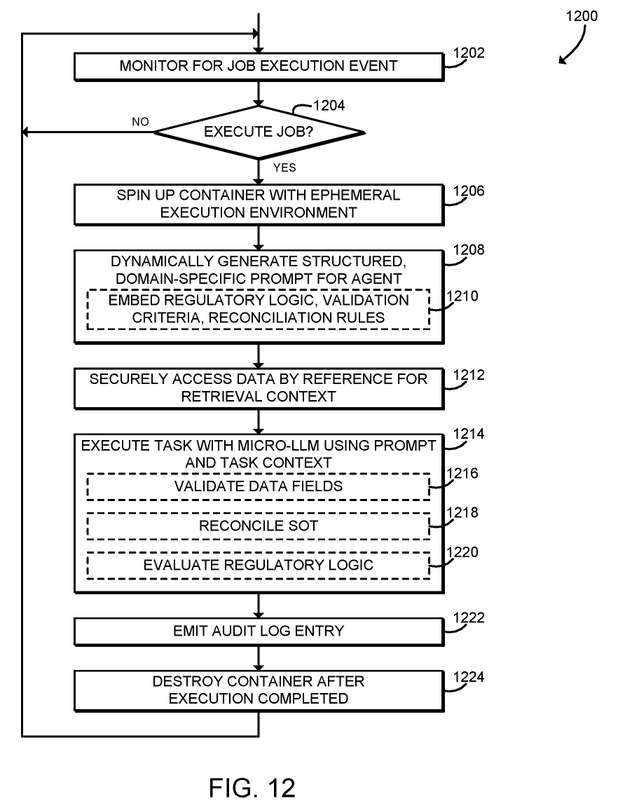

Referring now to FIG. 12, in use, a computing device 102 may execute a method 1200 for executing domain-specific deterministic task models. It should be appreciated that, in some embodiments, the operations of the method 1200 may be performed by one or more components of the environment 1100 of the computing device 102 as shown in FIG. 11. The method 1200 begins with block 1202, in which the computing device 102 monitors for a job execution event, such as an API call, a document creation, a milestone, or other event. For example, in an embodiment, job execution may be accessed via an API gateway with mutual TLS (mTLS) and Web Application Firewall (WAF) to filter inbound traffic and enforce rate limits. In block 1204, the computing device 102 determines whether to execute a job. If not, the method 1200 loops back to block 1202 to continue monitoring for job execution events. If the computing device 102 determines to execute a job, the method 1200 advances to block 1206.

In block 1206, the computing device 102 spins up or otherwise creates an ephemeral execution environment. In ephemeral execution or stateless processing, a task is executed in an isolated container that is destroyed after completion with no data persisted disk.

In block 1208, the computing device 102 dynamically generates a structured, domain-specific prompt for an agent. An agent is a reusable, fixed-function task runner orchestrated by the computing device 102, which may be implemented using a large language model (LLM). The prompt is an instruction executed by the LLM-powered agent to perform a subtask. Illustratively, the prompt is dynamically generated at runtime. In some embodiments, in block 1210 the computing device 102 embeds regulatory logic, validation criteria, and reconciliation rules across SOT and SOR fields in the agent prompt.

In block 1212, the computing device 102 securely accesses participant data by reference for generation of a retrieval context. The retrieval context may be generated in connection with retrieval-augmented generation (RAG), which is an artificial intelligence technology in which domain data is injected into an LLM prompt. The participant data may be stored, for example, in a system of record (SOR), which is a primary enterprise system holding authoritative data for a workflow stage. In an illustrative embodiment, the computing device 102 accesses the participant data using a data-by-reference model in which sensitive documents are accessed via signed, expiring URLs or tokenized APIs and are never transmitted in full. Such data-by-reference models may be implemented using JSON Web Token (JWT), which is a signed, time-bound token that authenticates task requests without exposing credentials. For example, in an embodiment, incoming payloads are signed with JWTs containing expiration (exp), request ID (jti), and checksum fields. Thus, sensitive documents are never transmitted in full, and outputs are limited to validation results and never include raw personally identifiable information (PII) or load data. In some embodiments, all personally identifiable information (PII) and/or nonpublic personal information (NPI) is encrypted in transit and at rest, and masking or field-level encryption is applied where applicable.

In block 1214, the computing device 102 executes a task with a micro-LLM using the generated prompt and task context. For example, the task context may include the retrieval context determined as described above. As described above, the micro-LLM is fine-tuned, domain-specific language model. Illustratively, the micro-LLM is specific to the residential mortgage domain and is thus trained on historical mortgage documents and regulatory schema. The agent task may include, for example, document classification, extraction, field-level data validation, source-of-truth resolution, discrepancy resolution, and compliance prompting tasks related to documents or other data in the associated domain. Retrieval inputs and knowledge-graph context (e.g., in the task context) guide inference, ensuring deterministic behavior. In some embodiments, in block 1216 the computing device 102 validates one or more data fields. In some embodiments, in block 1218 the computing device 102 reconciles a source-of-truth (SOT). The SOT may be an authoritative value for a given field after reconciliation. In some embodiments, in block 1220 the computing device 102 evaluates regulatory logic. Accordingly, the disclosed technologies execute verification logic in real time via stateless, LLM-driven agents that reconcile structured and unstructured data on a field-by-field basis. This represents an improvement over typical systems such as UiPath, Blend, or ICE Encompass RPA plug-ins, which simply automate form-filling or data routing.

In block 1222, the computing device 102 emits an audit log entry. The audit log entry may be stored in the audit log 1120, and may include an immutable record of the task (including prompt and/or task context) as well as task output. The audit log 1120 may be a tamper-evident log recording a task identifier, source, timestamp, and decision path. For example, in an embodiment the output may include output assertions or other data relevant to a residential mortgage document or other domain-specific output. As another example, all task-level executions may be logged with request identifier, timestamp, and agent signature, creating a tamper-evident audit trail. Anomaly detection may be applied to the audit log.

In block 1224, the computing device 102 destroys the ephemeral execution container after execution of the task is completed. Destroying the container may discard task data and, in some embodiments, securely wipe memory used by the container. Accordingly, the computing device 102 provides a stateless, containerized system that may not store any user, loan, or document data to disk or otherwise persist any participant data or other data used in execution of the task. The disclosed system thus produces structured, audit-ready verification and resolution of mortgage data requested to ensure each loan is saleable to secondary-market investors and readily serviceable post-closing. After destroying the container, the method 1200 loops back to block 1202 to continue monitoring for job execution events.

### EXAMPLES

Illustrative examples of the technologies disclosed herein are provided below. An embodiment of the technologies may include any one or more, and any combination of, the examples described below.

Example 1 includes a computing device for deterministic governance logic management, the computing device comprising: a control editor configured to define a first control as a deterministic assertion unit, wherein the first control references one or more canonical data elements in a reference ontology; a control publisher configured to (i) bind the first control to a first control pack, wherein the first control pack is associated with a first control pack version, and (ii) publish the first control pack with an immutable reference to the first control pack version; a policy editor configured to define a first policy associated with the first control pack for a governance context; and a governance publisher configured to deploy the first control pack and the first policy to a participant node within a sovereign boundary.

Example 2 includes the subject matter of Example 1, and wherein the reference ontology is aligned with a mortgage industry data model.

Example 3 includes the subject matter of any of Examples 1 and 2, and wherein the governance publisher is further configured to compose an agent with the first control pack and the first policy, wherein to deploy the first control and the first policy comprises to deploy the agent.

Example 4 includes the subject matter of any of Examples 1-3, and wherein to define the first control further comprises to define a certification assertion in terms of the one or more canonical data elements.

Example 5 includes the subject matter of Example 4, and wherein to define the certification assertion further comprises to define a plurality of assertion outcome classes selected from pass, fail, incomplete, and exception.

Example 6 includes the subject matter of any of Examples 1-5, and wherein to define the first control further comprises to define a source-of-truth for the one or more canonical data elements.

Example 7 includes the subject matter of any of Examples 1-6, and wherein to define the first control further comprises to define a threshold parameter.

Example 8 includes the subject matter of any of Examples 1-7, and wherein the first control pack is further associated with a first reference ontology version.

Example 9 includes the subject matter of any of Examples 1-8, and wherein to define the first policy comprises to specify one or more active control packs.

Example 10 includes the subject matter of any of Examples 1-9, and wherein to define the first policy comprises to define a threshold overlay.

Example 11 includes the subject matter of any of Examples 1-10, and wherein to define the first policy comprises to define required controls and optional controls of the first control pack.

Example 12 includes the subject matter of any of Examples 1-11, and wherein to define the first policy comprises to define an outcome classification configuration.

Example 13 includes the subject matter of any of Examples 1-12, and wherein the participant node activates the first control pack version associated with the first control pack.

Example 14 includes a computing device for deterministic governance control execution, the computing device comprising: a certification run manager configured to execute a certification run with a first control pack and a first policy in a participant sovereign node, wherein the certification run is associated with a first certificate run identifier; a participant data manager configured to (i) retrieve participant data from one or more data sources, wherein a data source of the one or more data sources is within a sovereign boundary associated with the participant sovereign node, and (ii) normalize the participant data to a unified internal representation with predetermined semantic definitions in a reference ontology; a control evaluator configured to evaluate a first control of the first control pack deterministically with the unified internal representation, wherein to evaluate the first control comprises to determine an assertion outcome; a certification manager configured to (i) determine a certification state in response to evaluation of the first control and (ii) generate a signed certification artifact indicative of the certification state, wherein the signed certification artifact is bound to the first certificate run identifier and is signed with a participant private key; and an execution logger configured to append the first certificate run identifier to an immutable execution log.

Example 15 includes the subject matter of Example 14, and wherein the reference ontology is aligned with a mortgage industry data model.

Example 16 includes the subject matter of any of Examples 14 and 15, and wherein: the certification run manager is further configured to (i) monitor for a certification run event, and (ii) activate the participant sovereign node in response to monitoring for the certification run event; and to execute the certification run comprises to execute the certification run in response to activation of the participant sovereign node.

Example 17 includes the subject matter of Example 16, and wherein to monitor for the certification run event comprises to monitor for a mortgage asset creation, a policy change, a control change, or an evidence change.

Example 18 includes the subject matter of any of Examples 14-17, and wherein to execute the certification run in the participant sovereign node comprises to execute within a trusted execution environment.

Example 19 includes the subject matter of any of Examples 14-18, and wherein to execute the certification run in the participant sovereign node comprises to activate external data protections.

Example 20 includes the subject matter of any of Examples 14-19, and wherein to execute the certification run in the participant sovereign node comprises to export telemetry indicative of a performance metric and a version identifier.

Example 21 includes the subject matter of any of Examples 14-20, and wherein to execute the certification run with the first control pack and the first policy comprises to verify that the first control pack is activated and not superseded.

Example 22 includes the subject matter of any of Examples 14-21, and wherein the certification run is further associated with a first mortgage asset identifier (MAI).

Example 23 includes the subject matter of any of Examples 14-22, and wherein to execute the certification run with the first control pack and the first policy comprises to apply a participant policy overlay to the first policy.

Example 24 includes the subject matter of any of Examples 14-23, and wherein to execute the certification run with the first control pack and the first policy comprises to specify a participant source-of-truth (SOT).

Example 25 includes the subject matter of any of Examples 14-24, and wherein to execute the certification run with the first control pack and the first policy comprises to generate a first execution contract bound to the first control pack and the first policy.

Example 26 includes the subject matter of any of Examples 14-25, and wherein the data source within the sovereign boundary associated comprises a structured system of record data source or a document-derived data source.

Example 27 includes the subject matter of any of Examples 14-26, and wherein to retrieve the participant data from the one or more data sources further comprises to retrieve participant data from a third-party data source outside the sovereign boundary.

Example 28 includes the subject matter of any of Examples 14-27, and wherein to retrieve the participant data from the one or more data sources further comprises to receive manual attestation data.

Example 29 includes the subject matter of any of Examples 14-28, and wherein to normalize the participant data to the unified internal representation comprises to preserve lineage metadata and source classification of the participant data.

Example 30 includes the subject matter of any of Examples 14-29, and wherein to normalize the participant data to the unified internal representation comprises to extract, to classify, or to structure evidence from unstructured data of the participant data with a large language model.

Example 31 includes the subject matter of any of Examples 14-30, and wherein to evaluate the first control of the first control pack deterministically with the unified internal representation comprises to: verify document presence and completeness; resolve document lineage authority and version; retrieve canonical data specified by the first control from the unified internal representation; and apply a source-of-truth hierarchy and resolving conflicts.

Example 32 includes the subject matter of any of Examples 14-31, and wherein the assertion outcome comprises pass, fail, incomplete, or exception.

Example 33 includes the subject matter of any of Examples 14-32, and wherein to determine the certification state comprises to aggregate a plurality of required assertion outcomes for a plurality of controls of the first control pack.

Example 34 includes the subject matter of any of Examples 14-33, and wherein to determine the certification state comprises to evaluate a completeness rule defined by the first policy.

Example 35 includes the subject matter of any of Examples 14-34, and wherein to determine the certification state comprises to apply exception logic.

Example 36 includes the subject matter of any of Examples 14-35, and wherein to generate the signed certification artifact comprises to bind the signed certification artifact to structured output from the first control of the first control pack.

Example 37 includes the subject matter of any of Examples 14-36, and wherein to append the first certificate run identifier to the immutable execution log further comprises to append a version reference to the immutable execution log.

Example 38 includes the subject matter of any of Examples 14-37, and wherein to append the first certificate run identifier to the immutable execution log further comprises to append structured output from the first control to the immutable execution log.

Example 39 includes a computing device for deterministic governance control replay, the computing device comprising: a verification manager configured to (i) receive a first execution contract and a first signed certification artifact, wherein the first execution contract is bound to a first control pack and a first policy, and wherein the first signed certification artifact is signed by a participant private key and is indicative of a first assertion outcome for the first control pack, and (ii) verify the first signed certification artifact; and a deterministic replay manager configured to (i) deterministically reproduce a second certification for the first execution contract in response to verification of the first signed certification artifact, wherein the second certification is indicative of a second assertion outcome for the first control pack, and (ii) compare the first signed certification artifact to the second certification, wherein to compare comprises to compare the first assertion outcome to the second assertion outcome.

Example 40 includes the subject matter of Example 39, and wherein to verify the first signed certification artifact comprises to validate a signature authenticity of the first signed certification artifact.

Example 41 includes the subject matter of any of Examples 39 and 40, and wherein to verify the first signed certification artifact comprises to validate version reference integrity of the first signed certification artifact.

Example 42 includes the subject matter of any of Examples 39-41, and wherein to deterministically reproduce the second certification for the first execution contract comprises to confirm a same evidence snapshot, confirm a same control pack version, confirm a same policy version, and confirm a same unified internal representation between the second certification and the first signed certification artifact.

Example 43 includes a computing device for executing domain-specific deterministic task models, the computing device comprising: a job manager configured to (i) monitor for a job execution event and (ii) create a first container with an ephemeral execution environment in response to monitoring for the job execution event; a prompt manager configured to dynamically generate, with the ephemeral execution environment, a domain-specific prompt for an agent; a data access manager configured to securely access, with the ephemeral execution environment, participant data by reference to create a retrieval context; a task orchestrator configured to execute, with the ephemeral execution environment, a first task with a micro-large language model (micro-LLM) using the domain-specific prompt and the retrieval context, wherein the micro-LLM comprises a fine-tuned, domain-specific language model; and an audit manager configured to emit, with the ephemeral execution environment, an audit log entry in response to execution of the first task; wherein the job manager is further configured to destroy the first container in response to the execution of the first task.

Example 44 includes the subject matter of Example 43, and wherein the domain-specific prompt and the domain-specific language model are specific to a regulated asset domain.

Example 45 includes the subject matter of Example 44, and wherein the regulated asset domain comprises a residential mortgage domain.

Example 46 includes the subject matter of any of Examples 43-45, and wherein to dynamically generate the domain-specific prompt comprises to embed regulatory logic, validation criteria, and reconciliation rules in the domain-specific prompt.

Example 47 includes the subject matter of any of Examples 43-46, and wherein to execute the first task comprises to validate a plurality of data fields of the participant data.

Example 48 includes the subject matter of any of Examples 43-47, and wherein to execute the first task comprises to reconcile a source-of-truth (SOT) for the participant data.

Example 49 includes the subject matter of any of Examples 43-48, and wherein to execute the first task comprises to evaluate regulatory logic.

Example 50 includes a method for deterministic governance logic management, the method comprising: defining, by a computing device, a first control as a deterministic assertion unit, wherein the first control references one or more canonical data elements in a reference ontology; binding, by the computing device, the first control to a first control pack, wherein the first control pack is associated with a first control pack version; publishing, by the computing device, the first control pack with an immutable reference to the first control pack version; defining, by the computing device, a first policy associated with the first control pack for a governance context; and deploying, by the computing device, the first control pack and the first policy to a participant node within a sovereign boundary.

Example 51 includes the subject matter of Example 50, and wherein the reference ontology is aligned with a mortgage industry data model.

Example 52 includes the subject matter of any of Examples 50 and 51, and further comprising composing, by the computing device, an agent with the first control pack and the first policy, wherein deploying the first control and the first policy comprises deploying the agent.

Example 53 includes the subject matter of any of Examples 50-52, and wherein defining the first control further comprises defining a certification assertion in terms of the one or more canonical data elements.

Example 54 includes the subject matter of Example 53, and wherein defining the certification assertion further comprises defining a plurality of assertion outcome classes selected from pass, fail, incomplete, and exception.

Example 55 includes the subject matter of any of Examples 50-54, and wherein defining the first control further comprises defining a source-of-truth for the one or more canonical data elements.

Example 56 includes the subject matter of any of Examples 50-55, and wherein defining the first control further comprises defining a threshold parameter.

Example 57 includes the subject matter of any of Examples 50-56, and wherein the first control pack is further associated with a first reference ontology version.

Example 58 includes the subject matter of any of Examples 50-57, and wherein defining the first policy comprises specifying one or more active control packs.

Example 59 includes the subject matter of any of Examples 50-58, and wherein defining the first policy comprises defining a threshold overlay.

Example 60 includes the subject matter of any of Examples 50-59, and wherein defining the first policy comprises defining required controls and optional controls of the first control pack.

Example 61 includes the subject matter of any of Examples 50-60, and wherein defining the first policy comprises defining an outcome classification configuration.

Example 62 includes the subject matter of any of Examples 50-61, and wherein the participant node activates the first control pack version associated with the first control pack.

Example 63 includes a method for deterministic governance control execution, the method comprising: executing, by the computing device, a certification run with a first control pack and a first policy in a participant sovereign node, wherein the certification run is associated with a first certificate run identifier; retrieving, by the computing device, participant data from one or more data sources, wherein a data source of the one or more data sources is within a sovereign boundary associated with the participant sovereign node; normalizing, by the computing device, the participant data to a unified internal representation with predetermined semantic definitions in a reference ontology; evaluating, by the computing device, a first control of the first control pack deterministically with the unified internal representation, wherein evaluating the first control comprises determining an assertion outcome; determining, by the computing device, a certification state in response to evaluating the first control; generating, by the computing device, a signed certification artifact indicative of the certification state, wherein the signed certification artifact is bound to the first certificate run identifier and is signed with a participant private key; and appending, by the computing device, the first certificate run identifier to an immutable execution log.

Example 64 includes the subject matter of Example 63, and wherein the reference ontology is aligned with a mortgage industry data model.

Example 65 includes the subject matter of any of Examples 63 and 64, and further comprising: monitoring, by a computing device, for a certification run event; and activating, by the computing device, the participant sovereign node in response to monitoring for the certification run event; wherein executing the certification run comprises executing the certification run in response to activating the participant sovereign node.

Example 66 includes the subject matter of Example 65, and wherein monitoring for the certification run event comprises monitoring for a mortgage asset creation, a policy change, a control change, or an evidence change.

Example 67 includes the subject matter of any of Examples 63-66, and wherein executing the certification run in the participant sovereign node comprises executing within a trusted execution environment.

Example 68 includes the subject matter of any of Examples 63-67, and wherein executing the certification run in the participant sovereign node comprises activating external data protections.

Example 69 includes the subject matter of any of Examples 63-68, and wherein executing the certification run in the participant sovereign node comprises exporting telemetry indicative of a performance metric and a version identifier.

Example 70 includes the subject matter of any of Examples 63-69, and wherein executing the certification run with the first control pack and the first policy comprises verifying that the first control pack is activated and not superseded.

Example 71 includes the subject matter of any of Examples 63-70, and wherein the certification run is further associated with a first mortgage asset identifier (MAI).

Example 72 includes the subject matter of any of Examples 63-71, and wherein executing the certification run with the first control pack and the first policy comprises applying a participant policy overlay to the first policy.

Example 73 includes the subject matter of any of Examples 63-72, and wherein executing the certification run with the first control pack and the first policy comprises specifying a participant source-of-truth (SOT).

Example 74 includes the subject matter of any of Examples 63-73, and wherein executing the certification run with the first control pack and the first policy comprises generating a first execution contract bound to the first control pack and the first policy.

Example 75 includes the subject matter of any of Examples 63-74, and wherein the data source within the sovereign boundary associated comprises a structured system of record data source or a document-derived data source.

Example 76 includes the subject matter of any of Examples 63-75, and wherein retrieving the participant data from the one or more data sources further comprises retrieving participant data from a third-party data source outside the sovereign boundary.

Example 77 includes the subject matter of any of Examples 63-76, and wherein retrieving the participant data from the one or more data sources further comprises receiving manual attestation data.

Example 78 includes the subject matter of any of Examples 63-77, and wherein normalizing the participant data to the unified internal representation comprises preserving lineage metadata and source classification of the participant data.

Example 79 includes the subject matter of any of Examples 63-78, and wherein normalizing the participant data to the unified internal representation comprises extracting, classifying, or structuring evidence from unstructured data of the participant data with a large language model.

Example 80 includes the subject matter of any of Examples 63-79, and wherein evaluating the first control of the first control pack deterministically with the unified internal representation comprises: verifying document presence and completeness; resolving document lineage authority and version; retrieving canonical data specified by the first control from the unified internal representation; and applying a source-of-truth hierarchy and resolving conflicts.

Example 81 includes the subject matter of any of Examples 63-80, and wherein the assertion outcome comprises pass, fail, incomplete, or exception.

Example 82 includes the subject matter of any of Examples 63-81, and wherein determining the certification state comprises aggregating a plurality of required assertion outcomes for a plurality of controls of the first control pack.

Example 83 includes the subject matter of any of Examples 63-82, and wherein determining the certification state comprises evaluating a completeness rule defined by the first policy.

Example 84 includes the subject matter of any of Examples 63-83, and wherein determining the certification state comprises applying exception logic.

Example 85 includes the subject matter of any of Examples 63-84, and wherein generating the signed certification artifact comprises binding the signed certification artifact to structured output from the first control of the first control pack.

Example 86 includes the subject matter of any of Examples 63-85, and wherein appending the first certificate run identifier to the immutable execution log further comprises appending a version reference to the immutable execution log.

Example 87 includes the subject matter of any of Examples 63-86, and wherein appending the first certificate run identifier to the immutable execution log further comprises appending structured output from the first control to the immutable execution log.

Example 88 includes a method for deterministic governance control replay, the method comprising: receiving, by a computing device, a first execution contract and a first signed certification artifact, wherein the first execution contract is bound to a first control pack and a first policy, and wherein the first signed certification artifact is signed by a participant private key and is indicative of a first assertion outcome for the first control pack; verifying, by the computing device, the first signed certification artifact; deterministically, by the computing device, reproducing a second certification for the first execution contract in response to verifying the first signed certification artifact, wherein the second certification is indicative of a second assertion outcome for the first control pack; and comparing, by the computing device, the first signed certification artifact to the second certification, wherein comparing comprises comparing the first assertion outcome to the second assertion outcome.

Example 89 includes the subject matter of Example 88, and wherein verifying the first signed certification artifact comprises validating a signature authenticity of the first signed certification artifact.

Example 90 includes the subject matter of any of Examples 88 and 89, and wherein verifying the first signed certification artifact comprises validating version reference integrity of the first signed certification artifact.

Example 91 includes the subject matter of any of Examples 88-90, and wherein deterministically reproducing the second certification for the first execution contract comprises confirming a same evidence snapshot, confirming a same control pack version, confirming a same policy version, and confirming a same unified internal representation between the second certification and the first signed certification artifact.

Example 92 includes a method for executing domain-specific deterministic task models, the method comprising: monitoring, by a computing device, for a job execution event; creating, by a computing device, a first container with an ephemeral execution environment in response to monitoring for the job execution event; dynamically generating, by the computing device with the ephemeral execution environment, a domain-specific prompt for an agent; securely accessing, by the computing device with the ephemeral execution environment, participant data by reference to create a retrieval context; executing, by the computing device with the ephemeral execution environment, a first task with a micro-large language model (micro-LLM) using the domain-specific prompt and the retrieval context, wherein the micro-LLM comprises a fine-tuned, domain-specific language model; emitting, by the computing device with the ephemeral execution environment, an audit log entry in response to executing the first task; and destroying, by the computing device, the first container in response to executing the first task.

Example 93 includes the subject matter of Example 92, and wherein the domain-specific prompt and the domain-specific language model are specific to a regulated asset domain.

Example 94 includes the subject matter of Example 93, and wherein the regulated asset domain comprises a residential mortgage domain.

Example 95 includes the subject matter of any of Examples 92-94, and wherein dynamically generating the domain-specific prompt comprises embedding regulatory logic, validation criteria, and reconciliation rules in the domain-specific prompt.

Example 96 includes the subject matter of any of Examples 92-95, and wherein executing the first task comprises validating a plurality of data fields of the participant data.

Example 97 includes the subject matter of any of Examples 92-96, and wherein executing the first task comprises reconciling a source-of-truth (SOT) for the participant data.

Example 98 includes the subject matter of any of Examples 92-97, and wherein executing the first task comprises evaluating regulatory logic.

Example 99 includes a computing device comprising: a processor; and a memory having stored therein a plurality of instructions that when executed by the processor cause the computing device to perform the method of any of Examples 50-98.

Example 100 includes one or more machine readable storage media comprising a plurality of instructions stored thereon that in response to being executed result in a computing device performing the method of any of Examples 50-98.

Example 101 includes a computing device comprising means for performing the method of any of Examples 50-98.

1. A computing device for deterministic governance logic management, the computing device comprising:
a control editor configured to define a first control as a deterministic assertion unit, wherein the first control references one or more canonical data elements in a reference ontology;
a control publisher configured to (i) bind the first control to a first control pack, wherein the first control pack is associated with a first control pack version, and (ii) publish the first control pack with an immutable reference to the first control pack version;
a policy editor configured to define a first policy associated with the first control pack for a governance context; and
a governance publisher configured to deploy the first control pack and the first policy to a participant node within a sovereign boundary.

2. The computing device of claim 1, wherein the reference ontology is aligned with a mortgage industry data model.

3. The computing device of claim 1, wherein the governance publisher is further configured to compose an agent with the first control pack and the first policy, wherein to deploy the first control and the first policy comprises to deploy the agent.

4. The computing device of claim 1, wherein to define the first control further comprises to define a certification assertion in terms of the one or more canonical data elements.

5. The computing device of claim 1, wherein to define the first control further comprises to define a source-of-truth for the one or more canonical data elements.

6. The computing device of claim 1, wherein the participant node activates the first control pack version associated with the first control pack.

7. A computing device for deterministic governance control execution, the computing device comprising:
a certification run manager configured to execute a certification run with a first control pack and a first policy in a participant sovereign node, wherein the certification run is associated with a first certificate run identifier;
a participant data manager configured to (i) retrieve participant data from one or more data sources, wherein a data source of the one or more data sources is within a sovereign boundary associated with the participant sovereign node, and (ii) normalize the participant data to a unified internal representation with predetermined semantic definitions in a reference ontology;
a control evaluator configured to evaluate a first control of the first control pack deterministically with the unified internal representation, wherein to evaluate the first control comprises to determine an assertion outcome;
a certification manager configured to (i) determine a certification state in response to evaluation of the first control and (ii) generate a signed certification artifact indicative of the certification state, wherein the signed certification artifact is bound to the first certificate run identifier and is signed with a participant private key; and
an execution logger configured to append the first certificate run identifier to an immutable execution log.

8. The computing device of claim 7, wherein the reference ontology is aligned with a mortgage industry data model.

9. The computing device of claim 7, wherein:
the certification run manager is further configured to (i) monitor for a certification run event, and (ii) activate the participant sovereign node in response to monitoring for the certification run event; and
to execute the certification run comprises to execute the certification run in response to activation of the participant sovereign node.

10. The computing device of claim 9, wherein to monitor for the certification run event comprises to monitor for a mortgage asset creation, a policy change, a control change, or an evidence change.

11. The computing device of claim 7, wherein to execute the certification run in the participant sovereign node comprises to execute within a trusted execution environment.

12. The computing device of claim 7, wherein to execute the certification run with the first control pack and the first policy comprises to verify that the first control pack is activated and not superseded.

13. The computing device of claim 7, wherein the certification run is further associated with a first mortgage asset identifier (MAI).

14. The computing device of claim 7, wherein to execute the certification run with the first control pack and the first policy comprises to apply a participant policy overlay to the first policy.

15. The computing device of claim 7, wherein to execute the certification run with the first control pack and the first policy comprises to specify a participant source-of-truth (SOT).

16. The computing device of claim 7, wherein to normalize the participant data to the unified internal representation comprises to extract, to classify, or to structure evidence from unstructured data of the participant data with a large language model.

17. The computing device of claim 7, wherein to evaluate the first control of the first control pack deterministically with the unified internal representation comprises to:
verify document presence and completeness;
resolve document lineage authority and version;
retrieve canonical data specified by the first control from the unified internal representation; and
apply a source-of-truth hierarchy and resolving conflicts.

18. The computing device of claim 7, wherein to determine the certification state comprises to aggregate a plurality of required assertion outcomes for a plurality of controls of the first control pack.

19. The computing device of claim 7, wherein to generate the signed certification artifact comprises to bind the signed certification artifact to structured output from the first control of the first control pack.

20. The computing device of claim 7, wherein to append the first certificate run identifier to the immutable execution log further comprises to append a version reference to the immutable execution log.

21. A method for deterministic governance control execution, the method comprising:
executing, by the computing device, a certification run with a first control pack and a first policy in a participant sovereign node, wherein the certification run is associated with a first certificate run identifier;
retrieving, by the computing device, participant data from one or more data sources, wherein a data source of the one or more data sources is within a sovereign boundary associated with the participant sovereign node;
normalizing, by the computing device, the participant data to a unified internal representation with predetermined semantic definitions in a reference ontology;
evaluating, by the computing device, a first control of the first control pack deterministically with the unified internal representation, wherein evaluating the first control comprises determining an assertion outcome;
determining, by the computing device, a certification state in response to evaluating the first control;
generating, by the computing device, a signed certification artifact indicative of the certification state, wherein the signed certification artifact is bound to the first certificate run identifier and is signed with a participant private key; and
appending, by the computing device, the first certificate run identifier to an immutable execution log.

22. The method of claim 21, further comprising:
monitoring, by a computing device, for a certification run event; and
activating, by the computing device, the participant sovereign node in response to monitoring for the certification run event;
wherein executing the certification run comprises executing the certification run in response to activating the participant sovereign node.

23. The method of claim 21, wherein executing the certification run in the participant sovereign node comprises executing within a trusted execution environment.

24. The method of claim 21, wherein evaluating the first control of the first control pack deterministically with the unified internal representation comprises:
verifying document presence and completeness;
resolving document lineage authority and version;
retrieving canonical data specified by the first control from the unified internal representation; and
applying a source-of-truth hierarchy and resolving conflicts.

25. The method of claim 21, wherein generating the signed certification artifact comprises binding the signed certification artifact to structured output from the first control of the first control pack.
